(19) United States
(12) Patent Application Publication
(10) Pub. No.: US 2012/0213429 A1
(43) Pub. Date: Aug. 23, 2012

(54) SYSTEM AND METHOD FOR EXTRACTING FLOWCHART INFORMATION FROM DIGITAL IMAGES

(75) Inventors: Bintu Gopalan Vasudevan, Bangalore (IN); Sorawish Dhanapanichkul, Bangkok (TH); Rajesh Balakrishnan, Bangalore (IN)

(73) Assignee: INFOSYS TECHNOLOGIES LIMITED, Bangalore (IN)

(21) Appl. No.: 13/073,064

(22) Filed: Mar. 28, 2011

(30) Foreign Application Priority Data
Feb. 17, 2011 (IN) 452/CHE/2011

(51) Int. Cl. G06K 9/34

(52) U.S. Cl. 382/162; 382/176

(57) ABSTRACT

A system and method for extracting flowchart information from digital images is provided. The method includes converting the digital flowchart image into a grayscale image and then binarizing the image. The method further includes extracting and masking text data from the binarized image. Further, flow lines connecting geometric components within the flowchart image are extracted and masked. The geometric components are classified into one or more categories and the flow line relationships between the geometric components are extracted. Finally, the extracted text data, flow line relationship information and geometric component information is stored in a database.

### FIELD OF INVENTION

The present invention relates to the analysis and use of software artifacts. More particularly, the present invention provides for extracting flowchart information from digital images.

### BACKGROUND OF THE INVENTION

Software engineering is the implementation of processes for development, maintenance and operation of software used in any application. An important aspect of software engineering is reusing existing software for efficient operation of a software system. Software reuse also helps in accelerating software development lifecycle.

One of the features of software reuse currently implemented in the industry is the reuse of information available in the form of software artifacts. A software artifact is a portion of a software development process containing useful information. Generally, software artifacts contain useful knowledge related to the features of a software system. Examples of software artifacts include use-cases, flowcharts, wireframe diagrams, activity diagrams, UML diagrams and the like.

A flowchart is a schematic representation of a process or an algorithm that illustrates the sequence of operations to be performed to get the solution of a problem. Nowadays, business organizations widely use software systems for implementing business processes. A majority of artifacts of a software system of a business organization may exist in the form of flowcharts. Flowcharts may be used to represent essential functions of an organizational process. Examples of the essential functions represented by a flowchart may include movement of materials through a machinery in a manufacturing process, flow of applicant information through a hiring process in a human resources department, etc.

In light of the above, there exists a need for extracting data from artifacts of a software system such as flowcharts, and storing the data in a format such that the data can be efficiently reused.

### SUMMARY OF THE INVENTION

A system and method for extracting flowchart information from digital images is provided. The digital flowchart image includes text data, geometric components and connecting flow lines. The method includes binarizing the digital flowchart image. Text data is then extracted from the binarized image using rectangular region growing segmentation technique. The method then includes extracting and masking flow lines connecting geometric components within the digital flowchart image. After the extraction and masking of flow lines, geometric components are extracted and classified into one or more categories. Classifying the geometric components may include recognizing the components and arranging them into one or more shape categories. Flow line relationship information between the geometric components is also extracted. Thereafter, the extracted text data, flow line relationship information and geometric component information is stored in a database. In various embodiments of the present invention, the digital flowchart image may be a binary image, a color image, a grayscale image, a multispectral image or a thematic image.

In an embodiment of the present invention, prior to binarizing the digital flowchart image, the image is converted into a grayscale image

In an embodiment of the present invention, one or more regions including text data are masked prior to extracting and masking flow lines connecting geometric components. Masking of the one or more regions includes converting pixels within the one or more bounded regions into background color of the digital flowchart image.

In an embodiment of the present invention, extracting text data using rectangular region growing segmentation technique includes marking rectangular boundaries around one or more regions bounded by clusters of connected pixels of text data. An iterative algorithm is then executed for extracting one or more segment blocks enclosing individual characters from the one or more regions. In an embodiment of the present invention, a heuristic algorithm is implemented for separating closely connected individual characters prior to executing the iterative algorithm Characters are recognized in each of the one or more segmented blocks using a neural network based Optical Character Recognition algorithm. Thereafter, the characters are translated using a character encoding scheme.

In an embodiment of the present invention, recognition of geometric components is implemented using back-propagation neural network technique. In another embodiment of the present invention, recognition of geometric components is implemented by comparing the geometric components with standard geometric shapes stored in a database. The comparison of geometric components is performed using Dynamic Time Warping algorithm.

In an embodiment of the present invention, the standard geometric shapes are stored by representing the shapes using boundary-based shape representation. Angular directions of pixel points along boundary of a geometric shape is used for describing the shape and slope of line within a threshold limit traced along the boundary is used to define and form shape vectors.

In an embodiment of the present invention, the extracted text data is stored along with its location information. The location information indicates location of bounded geometric components within which text data is stored.

In an embodiment of the present invention, the extracted geometric component information is stored along with location, height and width information.

In an embodiment of the present invention, the extracted text data, flow line relationship information and geometric component information is stored in XML format. In another embodiment of the present invention, the extracted text data, flow line relationship information and geometric component information is stored in Graph Exchange Language format.

### BRIEF DESCRIPTION OF THE ACCOMPANYING DRAWINGS

The present invention is described by way of embodiments illustrated in the accompanying drawings wherein:

FIG. 1 illustrates a flow diagram depicting a sample flowchart image;

FIG. 2 illustrates a representation of the processed sample flowchart image depicting the flowchart components of the flow diagram of FIG. 1 after character and line masking;

FIG. 3 illustrates a flow diagram depicting the method steps for extracting flowchart information from digital images;

FIG. 4 illustrates a shape descriptor for representing and describing geometric shapes extracted from a digital image;

FIG. 5 illustrates four sample shape descriptors for standard flowchart components;

FIG. 6 illustrates a dynamic time warping path used in recognizing an eclipse geometric shape;

FIG. 7 illustrates an exemplary neural network used in learning and recognition of flowchart shapes;

FIG. 8 illustrates a graph of theoretically calculated values of Root Mean Square (RMS) error versus number of iterations of training data, input to a neural network for flowchart component recognition; and

FIG. 9 illustrates a sample XML representation of a section of a flowchart image.

### DETAILED DESCRIPTION OF THE INVENTION

A system, method and computer program product for extracting information from software artifacts is provided. The present invention is more specifically directed towards extracting flowchart information from digital images. An exemplary scenario in which the present invention may be implemented is in a software system in which information about the processes and functions of the system are stored in flowchart image files. In order to enable an efficient reuse of this information, data in flowchart images is to be extracted and stored in a format that is widely used.

In an embodiment of the present invention, system, method and computer program product disclosed provides extracting data from flowchart image files. Data extracted from flowchart images includes text data, data describing geometric flowchart components and flow lines connecting the geometric components. Text data is data located in the flowchart image. Text data may be enclosed within geometric flowchart components representing steps of flow of a process or it may be located outside the flowchart components.

In various embodiments of the present invention, system, method and computer program product disclosed provides utilizing a technique for extracting text data from a flowchart image. The method includes converting flowchart image into a grayscale image. Further, the method includes binarizing the image and extracting character segment blocks from the image using region growing segmentation. Thereafter, individual characters are recognized using neural network based Optical Character Recognition (OCR).

In an embodiment of the present invention, system, method and computer program product disclosed provides for extracting and classifying flowchart components from the flowchart image. Prior to extracting flowchart components, text data as well as flow lines connecting the flowchart components are masked. Then, flowchart components are extracted using region growing segmentation technique and the components are recognized using a back-propagation neural network. The neural network utilized for recognizing the geometric components is a network trained in recognizing geometric shapes. In various embodiments of the present invention, a Dynamic Time Warping (DTW) approach is used to recognize flowchart component shapes.

In yet another embodiment of the present invention, the system, method and computer program product disclosed provides for storing the extracted text data, data describing geometric components and flow lines in an Extensible Markup Language (XML) format.

Hence, the present invention enables an efficient reuse of information stored in flowcharts. The present invention also enables a proficient manner of exporting and using data across various software systems due to the data being stored in XML format.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purpose of clarity, details relating to technical material that is known in the technical fields related to the invention have been briefly described or omitted so as not to unnecessarily obscure the present invention.

The present invention would now be discussed in context of embodiments as illustrated in the accompanying drawings.

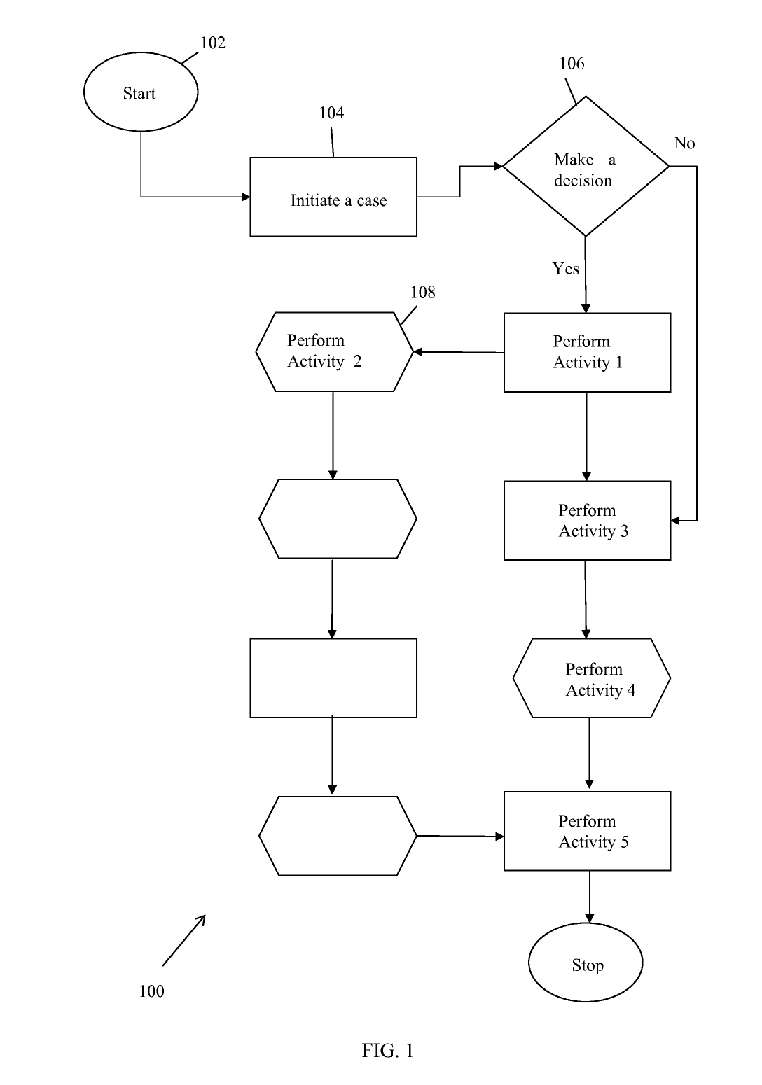

FIG. 1 illustrates a flow diagram depicting a sample flowchart image 100. In various embodiments of the present invention, the sample flowchart image 100 is a digital image comprising flowchart components arranged in a sequence to describe a process flow. A flowchart is a schematic representation of a process or an algorithm that illustrates the sequence of operations to be performed to get the solution of a problem. Flowcharts are commonly used in business/economic presentations to help the audience to visualize the content better, or to find flaws in the process, which describes what operations (and in what sequence) are required to solve a given problem. Flowcharts are usually drawn using standard geometric symbols such as rectangles, hexagons, circles, ellipses and lines. The standard geometric symbols represent start or end of a process, computational or processing steps, input or output operations, decision making/branching and flow lines. Examples of digital formats of flowchart images are JPEG, GIF, TIFF, PNG and BMP. The geometric symbols enclose concise text which provides information about the process being modeled. As shown in the figure, the sample flowchart image 100 comprises geometric symbols 102, 104, 106 and 108 which are flowchart components representing “start of process”, “process operation”, “decision making” and “value preparation for subsequent step” respectively.

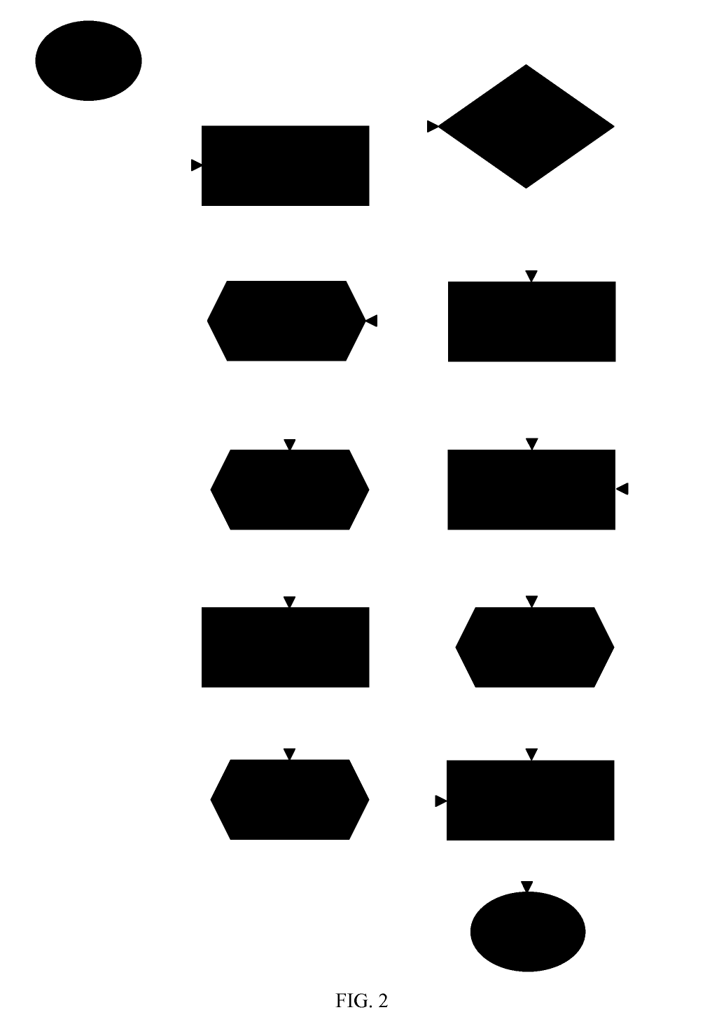

FIG. 2 illustrates a representation depicting the flowchart components of the sample flowchart image 100 depicted in FIG. 1 after the completion of character and line masking operations. Masking includes bitwise operations performed on the pixels of a digital image in order to hide certain portions of the image in order to perform operations on other portions of the image. In various embodiments of the present invention, character and line masking is used for processing the extraction of text and geometrical components from the flowchart image 100. Preprocessing is first performed on the flowchart image 100 to extract text (characters) located within flowchart image 100. In an embodiment of the present invention, preprocessing involves converting the flowchart image 100 to a grayscale image. The grayscale image is processed and a cluster of binary pixels is generated based on a global contrast threshold technique in which a threshold value for the entire image is ascertained based on intensity histogram. Thereafter, empirical experiments on the grayscale image are performed to determine a set of threshold values yielding a binary image in the form of cluster of black and white pixels. After the binarization of the image, the character segments are extracted. In various embodiments of the present invention, the character segments are extracted using region growing segmentation technique. Following the extraction of character segments, the character segments and the flow lines between the flowchart components are masked, before extracting the flowchart components. Flow lines are either horizontal or vertical lines connecting the flowchart components. In an embodiment of the present invention, the line masking is done by first detecting the horizontal lines first and the vertical lines second. The line detection is performed by processing the line pixels with the heuristic that the line pixels have a certain line width and that the line pixels are oriented in either horizontal or vertical direction. In various embodiments of the present invention, the arrow heads of the flow lines are not masked while performing the line masking. FIG. 2 illustrates the resultant image after the completion of binarization and line masking. The resultant image shows distinct components with geometrical shapes corresponding to the flowchart components of FIG. 1.

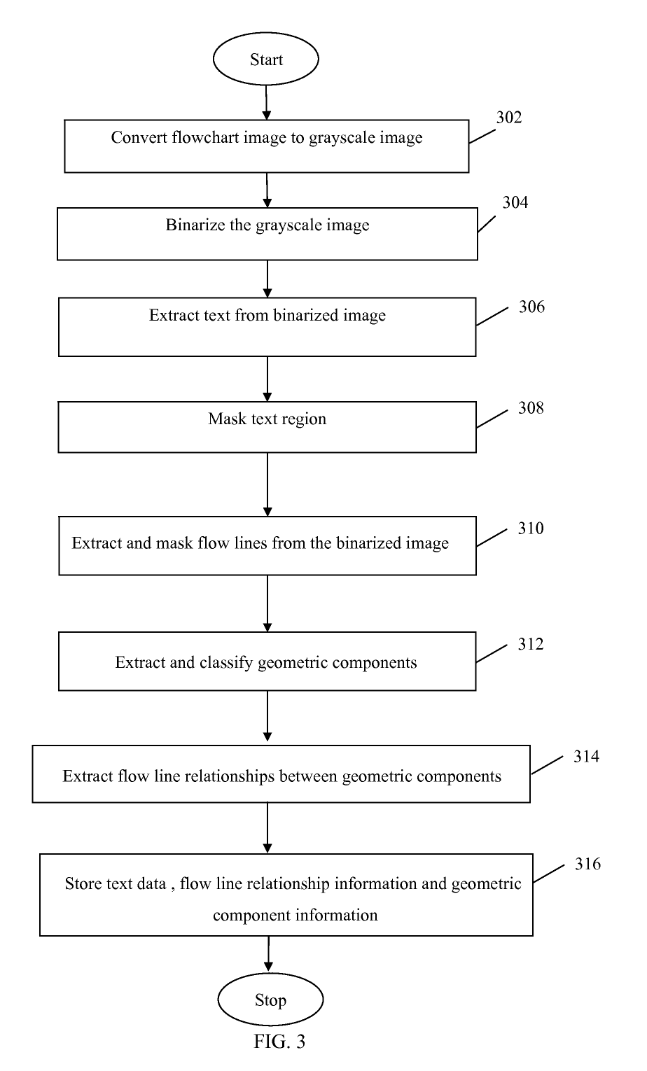

FIG. 3 illustrates a flow diagram depicting the method steps for automatically extracting flowchart information from a flowchart image. In various embodiments of the present invention, the flowchart image is a digital image having geometric components (symbols), text data and flow lines connecting the geometric components. A digital image is a binary representation of a two-dimensional image. Typically, a two-dimensional image is represented using pixels in a digital image, wherein a pixel is the smallest piece of information in a digital image comprising one or more bits. The one or more bits represent the color and intensity of the digital image. Examples of digital images include, but are not limited to, binary, color, grayscale, multi-spectral, thematic and the like. In an embodiment of the present invention, image processing techniques are used to extract text data, data describing geometric components and flow lines connecting the geometric components. At step 302, the flowchart image is converted into a grayscale image. A grayscale image is a representation of a color two-dimensional image in which each pixel of the grayscale image represents the color of the corresponding pixel in the color image by a value signifying the intensity of the color “gray”. In various embodiments of the present invention, a color image is converted to a grayscale image where each pixel in the Red-Green-Blue (RGB) format in the color image is converted into a corresponding gray pixel using the formula: GS=(0.299×R)+(0.587×G)+(0.114×B), where R, G and B represent the level or magnitude of Red, Blue and Green colors in an RGB pixel in the color image and GS represents the pixel in the grayscale image.

At step 304, the grayscale image is binarized. Image binarization comprises converting the grayscale image into a black-and-white image. Binarization is a process of simplifying the grayscale image in order to process it for information extraction, such as, extraction of text and geometric component information. In various embodiments of the present invention, thresholding techniques are used to binarize the grayscale image. A thresholding technique comprises choosing a threshold value and classifying all pixels in the grayscale image with value above the threshold value as white and all pixels with values below the threshold value as black. The thresholding technique can be applied by choosing two different threshold values: One threshold value results in an image with dark text in lighter background and the other threshold value results in an image with light text in dark background. Variations of the threshold technique include choosing an optimal threshold value for each area of the grayscale image and then classifying the pixels accordingly. The resultant image is a binary image in the form of a cluster of black and white pixels. At step 306, text is extracted from the binarized image. In an embodiment of the present invention, the resultant binary image is processed for text extraction by using a rectangular region growing segmentation technique. The rectangular region growing segmentation technique is a block segmentation technique in which a rectangular boundary around the cluster of connected pixels of text is marked for detecting characters. The rectangular region growing segmentation technique is a technique in which a region is allowed to grow in forward, backward, upward and downward direction for marking the rectangular boundary. An algorithm checks from left to right and top to bottom for left, top, right and bottom boundaries of the cluster of connected pixels. While going from left to right, the first black pixel is the left boundary and the last black pixel is the right boundary of the cluster of pixels. Similarly, for top to bottom, the first black pixel is the top boundary and the last black pixel is the bottom boundary of the connected pixels. In an embodiment of the present invention, the procedure implemented by the algorithm includes marking a rectangular boundary that is one pixel more than the region bounded by the cluster of connected pixels. The implementation of the algorithm yields a block segmented region with respect to certain number of pixels and characters along with their position and size information. The algorithm is further implemented iteratively on the block segmented region in order to extract the smallest possible segment block enclosing an individual character. The algorithm is iteratively implemented by imposing geometrical constraints in order to sort out individual character blocks. Examples of geometrical constraints include imposing a threshold limit for a width to height ratio corresponding to an individual character segment block. In certain example, 4 to 5 iterations are sufficient to extract individual character segment blocks when the characters are well separated from adjacent characters. In other embodiments, characters in text may not be well separated such as in digital images stored as compressed bmp/jpg/gif files. The compression may cause merging of closest adjacent characters. In these cases, if a block width to height ratio is greater than an average character segmented block ratio, a heuristic algorithm is used to separate the characters that are closely connected at the point of minimum pixel joining point.

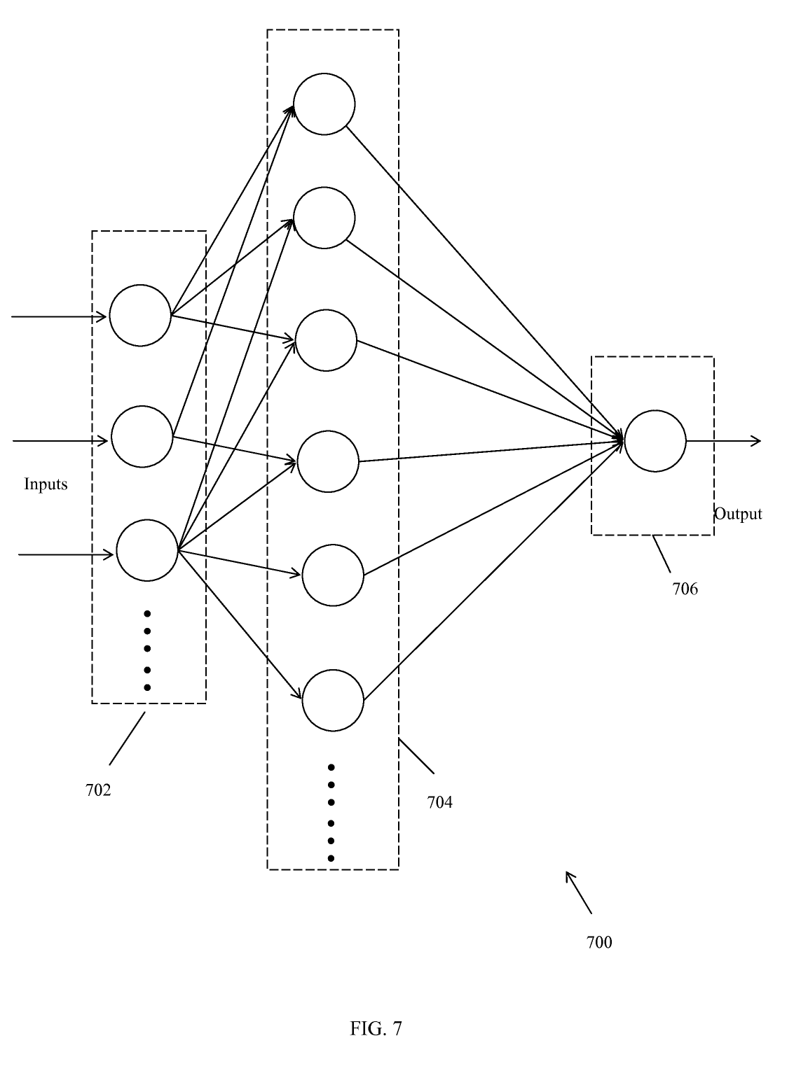

The block segmented region is then processed through a character recognition phase for recognizing the character images and translating them into a standard encoding scheme such as ASCII or Unicode. The characters in the block segmented region are recognized by a neural network based Optical Character Recognition (OCR) algorithm. A neural network is an adaptive software system of interconnected mathematical processing elements that provides an optimal solution to a problem based on a learning phase and a solution phase. In an embodiment of the present invention, the neural network is a back-propagation neural network. A back-propagation neural network is described in conjunction with the description of FIG. 7. In an embodiment of the present invention, for training the neural network database, character images database is generated from standard Windows system font. Font types such as Times New Roman, Arial and Courier are selected including font styles such as bold, italic and normal. Each font is then converted into a character image matrix of 26×26 pixels. Training database contains a set of input vectors of character image matrices and a set of output target vectors corresponding to character ASCII codes. The training database is applied to the neural network with various “neural network” configurations such as by varying number of layers, number of neurons in hidden layer, the activation function, the learning rate and the error limits. Consequent to training the database, the neural network is implemented to recognize the characters in the individual character segment blocks and to translate the characters into corresponding ASCII codes.

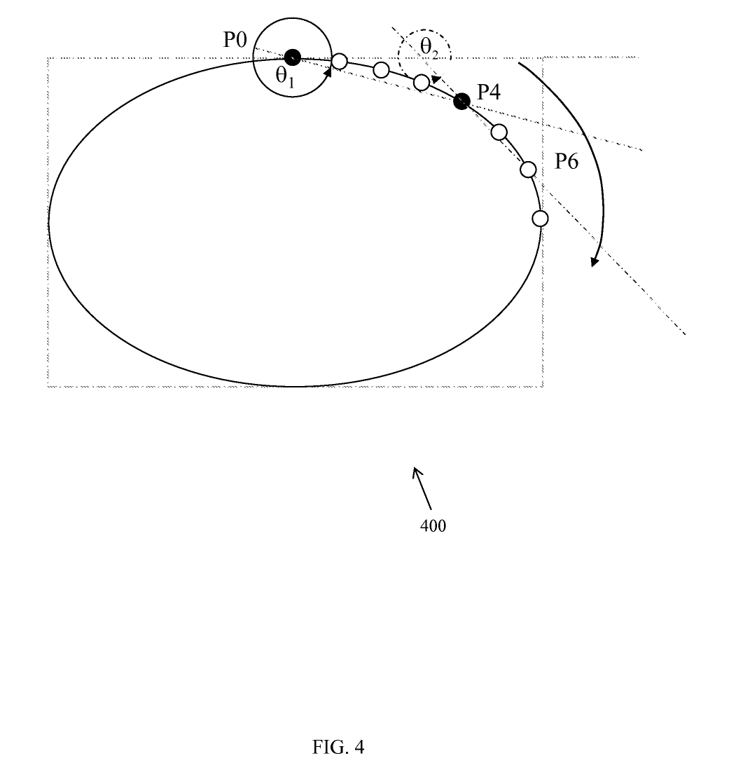

At step 308, the text region is masked. As described earlier, while using block segmentation technique for text extraction, rectangular boundaries around groups of connected pixels of text are marked for text identification. Since text boundaries are already known, all pixels within boundary areas are converted into background color of the image in order to mask text regions. In an embodiment of the present invention, wherein background color of an image is white in color as a result of image binarization, all pixels within text boundary areas are converted into white color. The resultant image obtained includes geometric components and connecting flow lines which are illustrated by black-colored pixels. Thereafter, at step 310, the flow lines connecting the geometric components are extracted and masked. In an embodiment of the present invention, flow line masking is done by processing pixels corresponding to the flow lines with the simple heuristic that the flow line pixels have a certain line width, and are oriented in either horizontal or vertical direction. During the masking of flow lines, the lines are labeled and their extreme points information is stored in a database. A resultant image after binarization and flow line masking shows distinct geometrical components with connected arrow head components. At step 312, the geometric components are extracted and classified. In an embodiment of the present invention, the geometric components are extracted by identifying clusters of connected pixels representing geometric shapes. The geometric components extracted from a digital image are then recognized and classified into categories. The classification of geometric components includes arranging the components into particular categories of shapes such as oval, square, hexagon, diamond and the like. In an embodiment of the present invention, for the purpose of recognizing geometric component shapes, a back-propagation neural network technique is used. In another embodiment of the present invention, for the purpose of recognizing geometric component shapes, a DTW algorithm is used, wherein the extracted component is compared with standard geometric shapes stored in database in order to determine a best match for recognition. As will be described further with reference to FIG. 4, the standard geometric shapes stored in database which are used for recognition are represented using various representation techniques.

At step 314, flow line relationships between geometric components are extracted. Extraction of flow line relationships is performed by tracing the flow lines based on the simple heuristic of detecting all flow lines and arrow heads connected to the geometric components. Additional information for identification includes pixels representing arrow heads connected to the components. In various embodiments of the present invention, a simple region growing segmentation technique is used to mark and label segment blocks with bounded box information that represent geometrical shapes. The arrow head components are separated while segmenting the geometric components. In various embodiments of the present invention, the separation criteria for separating the arrow head components is separating two components in region of minimal number of pixel link between two regions. The filtration of arrow head components is done by comparing the geometric components and the arrow head components based on a threshold. In an embodiment of the present invention, the tracing is done by starting with the top first geometric component bounded box, expanding the box boundary by one pixel area and tracking co-ordinates of any lines or arrow heads intersecting with the top first geometric component. The co-ordinates of the connected line are then used to trace the line to find an arrow head component connected to the other geometric component. The tracing of flow line is performed for all the geometric components to trace all flow line relationships between the components.

Finally, at step 316, the extracted text data, data describing geometric component shapes and flow line relationships are stored in a database. In various embodiments of the present invention, the extracted text data, the geometric components and the flow lines are stored in a database. In various embodiments of the present invention, the extracted text data, the geometric components and the flow lines are stored in an Extensible Markup Language (XML) format. XML is a markup language that provides a software and hardware independent manner of storing data so that the data can be shared across disparate software systems. In an embodiment of the present invention, the text data is stored along with its location information. The location information indicates the location of the bounded geometric component within which the characters are enclosed. The geometric components are stored with the location, width and height information. In other embodiments of the present invention, the extracted text data, the geometric components and the flow lines are stored in a Graph Exchange Language (GXL) format. The GXL format is an XML meta-language which is a standard for describing graphs across standard graph-based tools.

FIG. 4 illustrates a shape descriptor 400 for representing and describing geometric shapes extracted from a digital image. In various embodiments of the present invention, geometric shapes extracted from a digital image are classified by describing them and storing the description in a database such that the shapes can be recognized and restored later on. Pursuant to using segmentation technique to track and extract geometric components, a boundary-based shape representation technique is used for representing geometric shapes. In boundary-based shape representation, boundary outline of a geometric component is extracted by tracing the contour edges of the component. Following the tracing of the contour edges of the geometric component, the shape of the geometric component is represented by a sequence of values, each value corresponding to a segment direction. The segment direction corresponds to the direction of a straight line between two sample points on the contour edge of the geometric component. In an embodiment of the present invention, as shown in FIG. 4, the geometric component is traced by starting with an initial point P₀. Thereafter, a step L for any two consecutive sample points along the contour of the geometric component are chosen for creating a geometric shape descriptor. Then, the boundary of the geometric component is traced by using a straight line fit from the initial point P₀ to a sample point Pᵢ along the contour till the slope of the line is within a particular threshold limit. Once the particular threshold limit is reached, the sample point Pᵢ is pivoted and an angular direction (θᵢ) of Pᵢ with respect to a horizontal line is calculated. In the figure, the sample point Pᵢ which is pivoted is the point P₄. The geometric shape descriptor is a set of vectors comprising values of angular directions of sample points along the contour with respect to a horizontal line. Thus the angular direction (θ₁) of P₄ is stored in the geometric shape vector. The geometric shape descriptor of the geometric component is thus constructed as follows: A slope of line from P₀ to a sample point Pᵢ (P₄ in the figure) along the contour of the geometric component is calculated while the contour is traced clockwise. The sample point Pᵢ is pivoted as a consecutive sample point when the slope of line between the sample point and the horizontal line is within the particular threshold limit. Then, an angular direction of all pixel points between the P₀ to Pᵢ is assigned with the same direction. Hence, for all sample points between the sample point P₀ and the consecutive sample point Pᵢ, angular directions assigned to all the sample points is the angular direction (θᵢ). Thus, consecutive sample points along the contour of the geometric component are traced in a clockwise direction, angular directions for the sample points are calculated, assigned and stored in the geometric shape descriptor. The tracing is performed along the contour of the geometric component until the initial point P₀ is reached.

In various embodiments of the present invention, the tracing is performed by a software algorithm. The length of the vectors of the geometric shape descriptor is selected to be of a standard by selecting an average component segment size. A new component segment image is re-scaled to a standard segment image size before processing is done for creating a shape descriptor. The lengths of vectors in a geometric shape descriptor are made equal by re-sampling the vectors, when required.

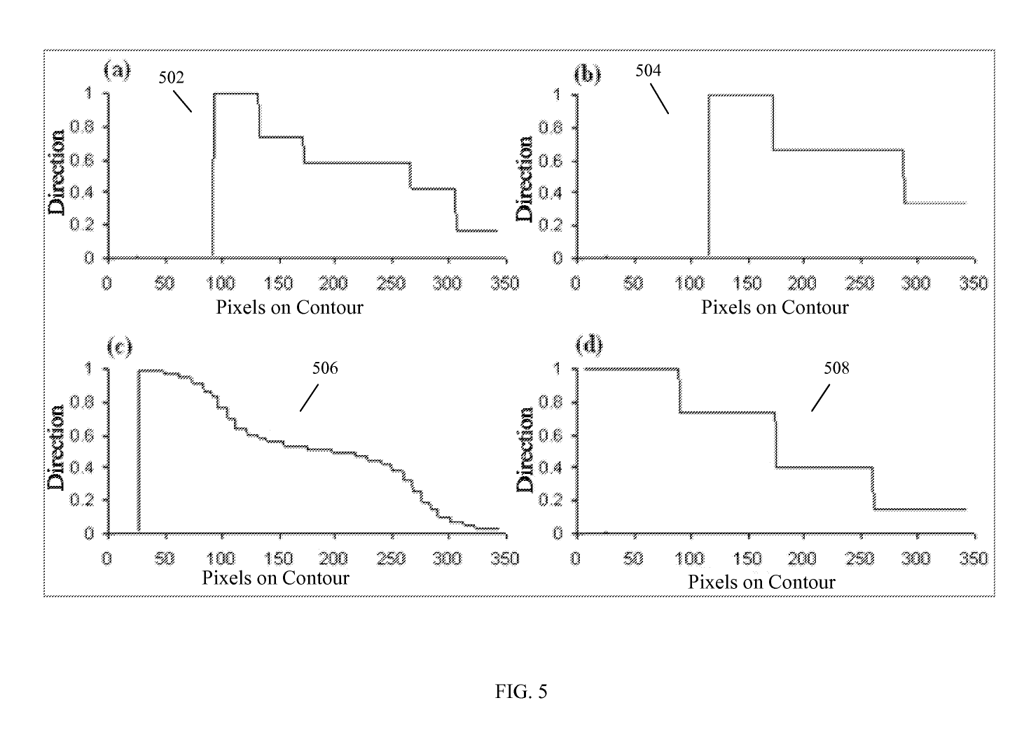

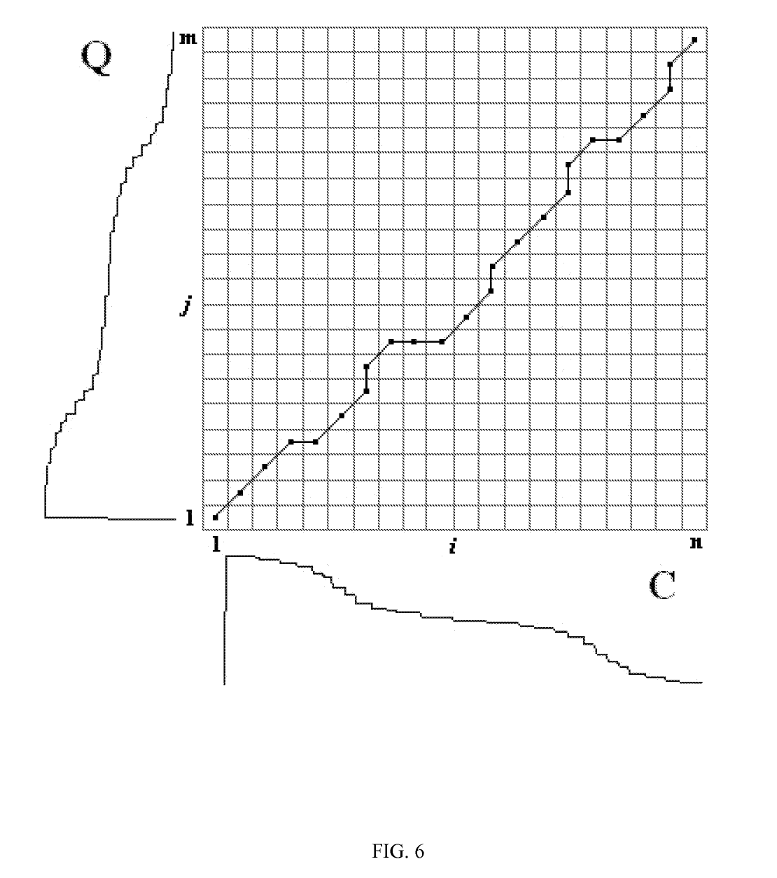

FIG. 5 illustrates four sample shape descriptors for standard flowchart components. In an embodiment of the present invention, the shape descriptors 502, 504, 506 and 508 represent the description of the geometric components hexagon, square, eclipse and diamond respectively. The shape descriptors 502, 504, 506 and 508 illustrate the direction of the pixels on the contours of the geometric shapes which is on the Y-axis and the number of sample pixel points on the X-axis in serial order. The shape descriptors represented and described for various geometric shapes are stored in a database. During recognition phase, a new shape descriptor is first re-sized to a standard size component and is re-sampled to a fixed length vector size before classification. In an embodiment of the present invention, a standard bounded size for a flowchart component is ascertained to be 160×80 pixels. A component block greater than this matrix is scaled down and centered to 160×80 pixels and a character less than this matrix is scaled up to this matrix size, while maintaining the aspect ratio of the flowchart component segments. Pursuant to representing shapes of standard flowchart components using geometric shape descriptors, the flowchart components are classified. The classification of flowchart components is described in conjunction with the description of FIGS. 5 and 6.

FIG. 6 illustrates a dynamic time warping path used in describing an eclipse geometric shape. As described in conjunction with the description of FIG. 5, standard flowchart component shapes are classified and stored in a database. Subsequently, a flowchart component extracted and described by using the shape descriptor recited in the description of FIG. 5 is compared with the shapes stored in the database to determine a best match for component recognition.

In various embodiments of the present invention, a Dynamic Time Warping (DTW) approach is used to detect an optimal alignment between two flowchart components. DTW is an algorithm that detects similarity between two sequences that are separated either in speed or time. A classic DTW algorithm is explained as follows:

Considering two time series

Q=(q1, q2, q3, . . . qi, . . . , qn) (A)

and

C=(c1, c2, c3, . . . cj, . . . , cm) (B)

of length n and m respectively. In order to align the two sequences using DTW we construct an n x m matrix where the (i^{th}, j^{th}) element of the matrix contains the distance “d(′ q₁i, c₁j) between the two points qᵢ and cⱼ. In an example, the distance between the two points qᵢ and cⱼ is the Euclidean distance function:

“ d(” q₁c₁j)=[(q₁i−c₁j)]^{†}2 (C)

Each matrix element corresponds to the alignment between the points qᵢ and cⱼ. A warping path is defined as a contiguous set of matrix elements that defines a mapping between Q and C. FIG. 6 illustrates an example. W of a warping path for the eclipse shape vector. The k^{th} element of W is defined as wₖ=(i, j)ₖ, so that we have:

W=(w₁, w₂, . . . , wₖ, . . . w_{K}), max(m, n)≦K<m+n−1 (D)

The warping path is subject to several constraints such as boundary conditions, continuity and monotonicity. In various embodiments of the present invention, the constraints can be:
Boundary Conditions: w₁=(1, 1) and W_{K}=(m, n). This boundary condition requires the warping path to start and finish at diagonally opposite corner cells of the matrix
Continuity: Given wₖ=(a, b), wₖ₋₁=(a′, b′) where a−a′≦1 and b−b′≦1. This constraint restricts the allowable steps in the warping path to adjacent cells. In an example, adjacent cells include diagonally adjacent cells
Monotonicity: Given w^{k}=(a, b) and w₁(k−1)=(a^{†}′, b^{†}′) where a−a′≦0 and b−b′≦0. This constraint forces the points in the warping path W to be monotonically spaced in time.
   There are exponentially multiple warping paths that may satisfy the constraints. In an embodiment of the present invention, the warping path that minimizes the warping cost is used which is defined as:

$$DTW ( Q , C ) = min \{ \sqrt{{\sum }_{k = 1}^{K} {w}_{k}} \} \qquad ( E )$$

The length K, of the warping path is bounded such that max(m, n)<m+n−1. We have used the global constraints on the warping path.

In an embodiment of the present invention, the DTW algorithm is implemented to find the best match for a flowchart component in the database having standard flowchart component shapes. The implementation is done as follows:

The standard flowchart component shapes in the database are scaled to 160×80 pixels, signatures are derived from all points on the shape boundaries and the shape vector is generated which is sampled to 350 points. Any variation in the number of points for a new shape vector is re-sampled to a vector size of 350. K, the length of the warping path is bounded such that max(m, n) ≦K<m+n−1. Since all the shape vectors are re-sampled to a standard vector size of 350, we have m=n, and m≦K<2m−1.
W is defined as the amount of warping implied by an algorithm:

$$W = \frac{K - m}{m} 0 \leq W < 1$$

If the algorithm discovers no warping between the sequences, W=0. The more the warping discovered, the larger will be the value of W. (The maximum value of W=1).

As an example for illustrating the implementation of the DTW algorithm, a set of geometric shape vectors were compared with the standard flowchart component shapes stored in the database. The sequence of each geometric shape vector was compared to each sequence of the standard flowchart component shapes and the average value of W is calculated. The results signifying the amount of warping between standard component shapes are:

| Shapes | Mean W for DTW |
|---|---|
| Eclipse | 0.11 |
| Hexagon | 0.12 |
| Square | 0.08 |

In an embodiment of the present invention, if a new geometric shape has a vector length smaller than the vector length of a stored geometric shape, the vector length of the stored geometric shape can be down-sampled to the length of the new geometric shape.

FIG. 7 illustrates an exemplary neural network 700 is used in learning and recognition of flowchart shapes. In various embodiments of the present invention, a neural network approach is used for recognition of flowchart components using neural networks. A neural network is an adaptive software system of interconnected mathematical processing elements that provides an optimal solution to a problem based on a learning phase and a solution phase. A neural network is implemented using a software algorithm. The mathematical processing elements are termed as neurons. A learning phase is a phase in which the neural network changes it structure in order to arrive at an optimum structure required for obtaining the solution for a given task. Change of structure of a neural network includes changing the topology of the interconnected mathematical processing elements in order to adapt the topology that is required to obtain the optimum solution. The learning phase is implemented by providing training data (set of tasks) to the neural network and letting the network adapt its topology to calculate the solution for a task. As an example, with a sufficiently large number of tasks given to the neural network in the learning phase, the neural network adapts continually with each task. In the solution phase, the adapted neural network is used to obtain the solution for a new task.

In various embodiments of the present invention, a back-propagation neural network 700 is used for recognizing flowchart components that have been extracted from a flowchart image. A back-propagation neural network is a multi-layer neural network implementing a back-propagation algorithm, where each layer comprises of neurons having specific functions. The basic layers of a multi-layer neural network are an input layer, a hidden layer and an output layer. The back-propagation neural network 700 comprises a first set of neurons 702 in the input layer that are configured to receive inputs. The first set of neurons 702 are connected to a second set of neurons 704 in the hidden layer. Thus, the input signals fed into the first set of neurons 702 are propagated through the second set of neurons 704 to a third set of neurons 706 at the output. Any connection between two neurons in the back-propagation neural network 700 has a unique weight value. In the learning phase, sample inputs signals are applied to the first set of neurons 702, for which the correct output values are known. The input signals are mathematically processed by the first set of neurons 702, transmitted through the hidden layer and the output is obtained after processing at the third set of neurons 706. The output obtained is dependent upon the individual weight values of the neuron connections. The difference between the output obtained and the correct output is an error value that is fed back to the network. Based on the error value, the individual weights of the neuron connections are slightly altered and the output value from the third set of neurons 706 is calculated again followed by the calculation of a new error value. A number of iterations of such calculations are repeated till the neural network 700 “learns” the weight values to be applied to the neuron connections across the layers such that the error value in less than a threshold limit.

As mentioned earlier, the back-propagation neural network 700 is used for recognizing flowchart components extracted from a flowchart image by training the network first in the learning phase. In an embodiment, shape vectors for standard flowchart shape components are generated for training the neural network 700. For example, a standard bounded size for the standard component shapes is determined to be 160×80 pixels and a standard number of sampled points for describing the shape vector is considered to be 350. Any variation in the number of points for a new shape vector is re-sampled to a vector size of 350. A back-propagation algorithm for training the neural network 700 inputs a test data set containing the shape vectors and the correct known output vectors to the neural network 700. Additionally, the shape vector data is perturbed with a gaussian noise of ±3 standard deviation of pixels and with zero mean in order to train the neural network. This ensures that the network is able to adapt itself for numerous variations in shapes. In various embodiments of the present invention, the back-propagation training algorithm implements various modes for training the neural network 700 such as varying the number of network layers, the number of neurons in the hidden layer, the activation function, the learning rate and the threshold error limit. The training algorithm was implemented to minimize a Root Mean Square (RMS) error value between a correct known output vector and the output vector processed by the neural network 700. Experimental values for RMS error values determined by implementing the training algorithm in various modes are illustrated in the description of FIG. 7.

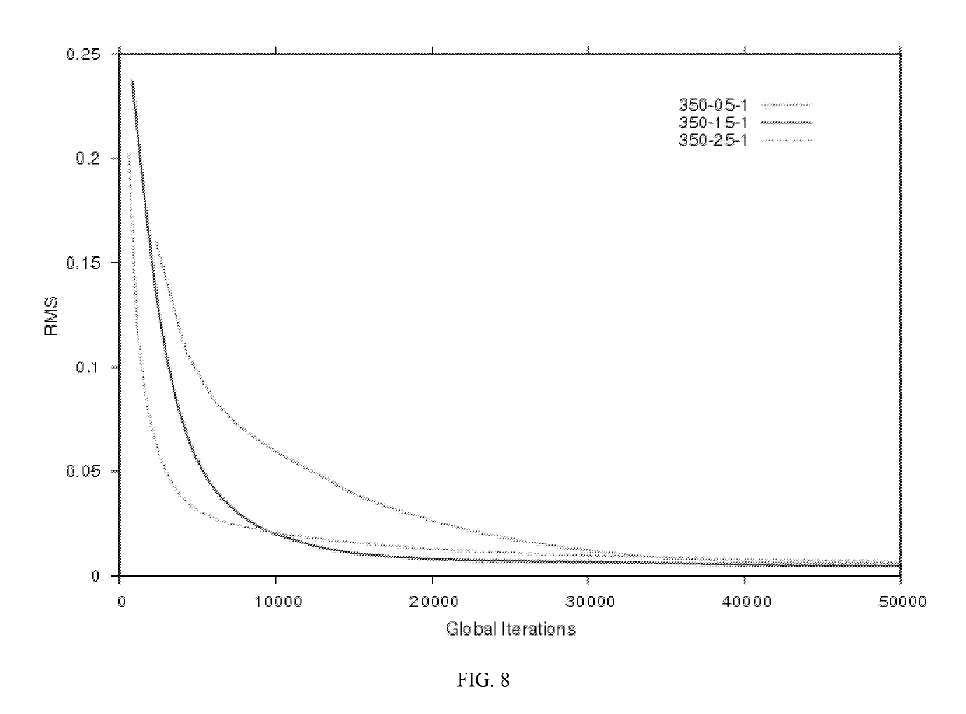

FIG. 8 illustrates a graph of theoretically calculated values of Root Mean Square (RMS) error versus number of iterations of training data input to a neural network for flowchart component recognition. An algorithm for training the back-propagation neural network 700 recited in the description of FIG. 7 is used for recognizing flowchart shapes extracted from a flowchart image. In various embodiments of the present invention, the algorithm implements the neural network 700 in various topologies to obtain optimum performance in recognition of flowchart shapes. FIG. 8 illustrates theoretical RMS error performance of three topologies of the neural network 700. The three topologies are as follows:
1) 350-05-1: A hidden layer with 5 neurons, an input vector size of 350 and a single vector at the output.
2) 350-15-1: A hidden layer with 15 neurons, an input vector size of 350 and a single vector at the output.
3) 350-25-1: A hidden layer with 25 neurons, an input vector size of 350 and a single vector at the output.

In an embodiment of the present invention, theoretical RMS error values were calculated for the three topologies of the neural network 700 by increasing the number of iterations performed for each neural network configuration. As illustrated in FIG. 8, the minimum RMS error obtained with an increase in the number of iterations is approximately the same. However, the 350-25-1 configuration has a higher rate of convergence as compared to the configurations having 5 and 15 neurons in the hidden layer but attains a higher minimum RMS error as compared to the 350-15-1 configuration. The 350-15-1 configuration is found to be the optimal configuration obtaining a minimum theoretical RMS error of 0.0047 compared to 0.0059 for the 350-05-1 configuration and 0.0089 for the 350-25-1 configuration for a training period of 50,000 iterations. In an exemplary case, if the number of iterations for the 350-05-1 configuration is increased to 80,000, the minimum RMS error converges to 0.0050 as compared to the minimum RMS error of 0.0047 for the 350-15-1 configuration. Thus, the 350-15-1 configuration exhibits an optimum performance with a learning error limit of 0.0003, a learning rate of 0.3 and a training period of 50,000 iterations.

In another embodiment of the present invention, the performance of the three neural network configurations were experimentally tested by training the three configurations using a database having 100 different geometrical shape vectors. The following table illustrates the RMS errors for the three configurations based on the experimental tests.

TABLE I

| Neural Network | |
|---|---|
| Configuration | RMS error |
| 350-05-1 | 0.0094 |
| 350-15-1 | 0.0055 |
| 350-25-1 | 0.0129 |

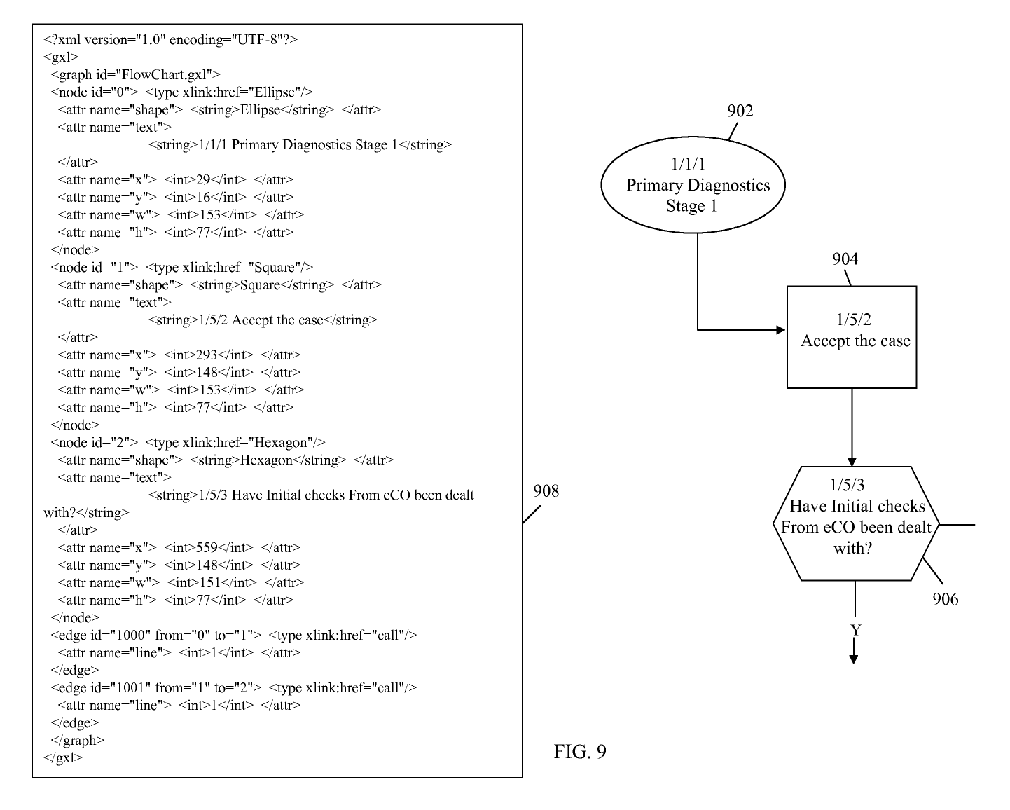

FIG. 9 illustrates a sample XML representation of a section of a flowchart image. In various embodiments of the present invention, the text data, geometric components and flow lines extracted from a flowchart image are stored in XML format. XML is a standard markup language commonly used for representing data stored in software documents that can be easily shared across various software platforms. Thus, storing the text, geometric components and flow lines in XML format helps in easy extraction and reuse of information. FIG. 9 shows a section of a sample flowchart image having the geometric components 902, 904, 906 and the corresponding XML representation 908.

The present invention may be implemented in numerous ways including as a system, a method, or a computer readable medium such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

What is claimed is:

1. A method for extracting data from a digital flowchart image, the digital flowchart image comprising text data, geometric components and connecting flow lines, the method comprising:
binarizing the digital flowchart image;
extracting text data from the binarized image using rectangular region growing segmentation technique;
extracting and masking flow lines connecting geometric components within the digital flowchart image;
extracting and classifying the geometric components into one or more categories, wherein classifying the geometric components comprises recognizing the geometric components and arranging them into one or more shape categories;
extracting flow line relationships between the geometric components;
and
storing the extracted text data, flow line relationship information and geometric component information in a database.

2. The method of claim 1, wherein one or more regions comprising text data are masked prior to extracting and masking flow lines connecting geometric components.

3. The method of claim 2, wherein masking one or more regions comprising text data comprises converting pixels within the one or more bounded regions into background color of the digital flowchart image.

4. The method of claim 1, wherein the digital flowchart image is at least one of a binary image, a color image, a grayscale image, a multispectral image and a thematic image.

5. The method of claim 1, wherein extracting text data using rectangular region growing segmentation technique comprises:
marking rectangular boundaries around one or more regions bounded by clusters of connected pixels of text data;
executing an iterative algorithm for extracting one or more segment blocks enclosing individual characters from the one or more regions, wherein the iterative algorithm is implemented by imposing geometrical constraints for extracting the one or more segment blocks;
recognizing characters in each of the one or more segmented blocks using a neural network based Optical Character Recognition algorithm;
and
translating the characters using a character encoding scheme.

6. The method of claim 5, wherein a heuristic algorithm is implemented for separating closely connected individual characters prior to executing the iterative algorithm.

7. The method of claim 1, wherein the geometric components are recognized using back-propagation neural network technique.

8. The method of claim 1, wherein the geometric components are recognized by comparing the geometric components with standard geometric shapes stored in a database, further wherein the comparison is performed using Dynamic Time Warping algorithm.

9. The method of claim 8, wherein the standard geometric shapes are stored by representing the shapes using boundary-based shape representation, further wherein angular directions of pixel points along boundary of a geometric shape is used for describing the shape and slope of line within a threshold limit traced along the boundary is used to define and form shape vectors.

10. The method of claim 1, wherein the extracted text data is stored along with its location information, further wherein the location information indicates location of bounded geometric components within which text data is stored.

11. The method of claim 1, wherein the extracted geometric component information is stored along with location, height and width information.

12. The method of claim 1, wherein the extracted text data, flow line relationship information and geometric component information is stored in XML format.

13. The method of claim 1, wherein the extracted text data, flow line relationship information and geometric component information is stored in Graph Exchange Language format.

14. A method for extracting data from a digital flowchart image, the digital flowchart image comprising text data, geometric components and connecting flow lines, the method comprising:
converting the digital flowchart image into a grayscale image;
binarizing the grayscale image;
extracting text data from the binarized image using rectangular region growing segmentation technique;
masking one or more regions comprising text data;
extracting and masking flow lines connecting geometric components within the digital flowchart image;
extracting and classifying the geometric components into one or more categories, wherein classifying the geometric components comprises recognizing the geometric components and arranging them into one or more shape categories;
extracting flow line relationships between the geometric components;
and
storing the extracted text data, flow line relationship information and geometric component information in a database.

15. A computer program product comprising a computer usable medium having a computer readable program code embodied therein for extracting data from a digital flowchart image, the digital flowchart image comprising text data, geometric components and connecting flow lines, the computer program product comprising:
program instruction code for binarizing the digital flowchart image;
program instruction code for extracting text data from the binarized image using rectangular region growing segmentation technique;
program instruction code for extracting and masking flow lines connecting geometric components within the digital flowchart image;
program instruction code for extracting and classifying the geometric components into one or more categories, wherein classifying the geometric components comprises program instruction code for recognizing the geometric components and arranging them into one or more shape categories;
program instruction code for extracting flow line relationships between the geometric components;
and
program instruction code for storing the extracted text data, flow line relationship information and geometric component information in a database.

16. The computer program product of claim 15 further comprising program instruction code for masking one or more regions comprising text data prior to extracting and masking flow lines connecting geometric components.

17. The computer program product of claim 16, wherein program instruction code for masking one or more regions comprising text data comprises program instruction code for converting pixels within the one or more bounded regions into background color of the digital flowchart image.

18. The computer program product of claim 15, wherein program instruction code for extracting text data using rectangular region growing segmentation technique comprises:
program instruction code for marking rectangular boundaries around one or more regions bounded by clusters of connected pixels of text data;
program instruction code for executing an iterative algorithm for extracting one or more segment blocks enclosing individual characters from the one or more regions;
program instruction code for recognizing characters in each of the one or more segmented blocks using a neural network based Optical Character Recognition algorithm;
and
program instruction code for translating the characters using a character encoding scheme.

19. The computer program product of claim 15, wherein program instruction code for recognizing the geometric components comprises:
program instruction code for storing standard geometric shapes in a database;
and
program instruction code for comparing the geometric components with the standard geometric shapes using Dynamic Time Warping algorithm.

20. The computer program product of claim 19, wherein program instruction code for storing standard geometric shapes comprises program instruction code for representing the shapes using boundary-based shape representation, further wherein representing the shapes using boundary-based shape representation comprises program instruction code for using angular directions of pixel points along boundary of a geometric shape for describing the shape and using slope of line within a threshold limit traced along the boundary to define and form shape vectors.

21. A computer program product comprising a computer usable medium having a computer readable program code embodied therein for extracting data from a digital flowchart image, the digital flowchart image comprising text data, geometric components and connecting flow lines, the computer program product comprising:
program instruction code for converting the digital flowchart image into a grayscale image;
program instruction code for binarizing the digital flowchart image;
program instruction code for extracting text data from the binarized image using rectangular region growing segmentation technique;
program instruction code for extracting and masking flow lines connecting geometric components within the digital flowchart image;
program instruction code for extracting and classifying the geometric components into one or more categories, wherein classifying the geometric components comprises program instruction code for recognizing the geometric components and arranging them into one or more shape categories;
program instruction code for extracting flow line relationships between the geometric components;
and
program instruction code for storing the extracted text data, flow line relationship information and geometric component information in a database.
